(19) United States
(12) Patent Application Publication
(10) Pub. No.: US 2016/0221203 A1
(43) Pub. Date: Aug. 4, 2016

(54) Ribbon Cutter

(71) Applicants: Jeff's Circle Inc., Mississauga (CA); Samster Corporation, Toronto (CA); Sloan Holdings Inc., Toronto (CA)

(72) Inventor: Michael Crispel, Toronto (CA)

(21) Appl. No.: 14/991,463

(22) Filed: Jan. 8, 2016

(30) Foreign Application Priority Data
Jan. 9, 2015 (CA) 2877252

(51) Int. Cl. B26D 1/08; B26D 5/10

(52) U.S. Cl. CPC B26D 1/085; B26D 5/10

(57) ABSTRACT

A ribbon cutter comprises a base and a turntable rotationally mounted on the base for movement between a plurality of rotational angles relative to a feed direction of the ribbon. A cutting arm pivotally connected to the turntable moves between an open position and a cutting position for cutting the ribbon at a selected angle determined by a rotational position of the turntable. A ribbon guide is provided for feeding a ribbon over the turntable, comprising an opening for manually drawing the ribbon through the ribbon guide to the turntable.

### FIELD OF THE INVENTION

This invention relates to cutting tools.

### BACKGROUND OF THE INVENTION

There are many different applications for the use of elongated sheets or strips of material that need to be custom-cut on site.

One example is hair colouring strips. During the hair colouring process a professional colourist will cut strips of aluminium foil, apply a hair dye to a bunch of hair strands, and wrap the foil around the coloured strands to encapsulate the dye while it sets into the hair and dries.

This process has certain disadvantages. Foil has essentially no thermal insulation value, and therefore cannot keep the colouring dye warm during the colouring process, which affects the permanence of the colouring. In the preferred embodiment a thin (5 mil) polystyrene foam strip is used in place of foil for hair colouring purposes. The wrapped polystyrene creates thermal conditions that are better for colouring than foil, and retains moisture for consistency of colouring.

Other uses for custom-cut strips from a ribbon include (without limitation) drywall tape, which must be cut to size to cover a joint between adjacent sheets of drywall; gift wrapping applications such as decorative ribbons; wallpaper borders; double-sided tape; and medical materials such as bandages.

For many such applications, one or both ends of a strip may need to be mitred, i.e. cut at an oblique angle. In some cases, for example when cutting drywall tape, the precision of the mitre is an important factor toward getting good results. Presently such strips are cut using scissors or a utility knife, which does not lend itself to cutting at precise angles and can lead to gaps or thickness overages in some applications.

It would accordingly be beneficial to provide a ribbon cutter capable of quickly and easily cutting mitred ends having specific and varying angles, with a high degree of precision.

### BRIEF DESCRIPTION OF THE DRAWINGS

In drawings which illustrate one or more embodiments of the invention by way of example only,

FIG. 1 is a perspective view of a ribbon cutter according to the invention.

FIG. 2 is a perspective view of a base for the ribbon cutter of FIG. 1.

FIG. 3 is a perspective view of a turntable support for mounting to the base.

FIG. 4 is a perspective view of a ribbon feeder for mounting to the base.

FIG. 5 is a side elevation of the ribbon feeder and turntable support mounted to the base.

FIG. 6 is a perspective view of the ribbon feeder and turntable support mounted to the base.

FIG. 7 is an exploded perspective view of the turntable and cutting arm.

### DETAILED DESCRIPTION OF THE INVENTION

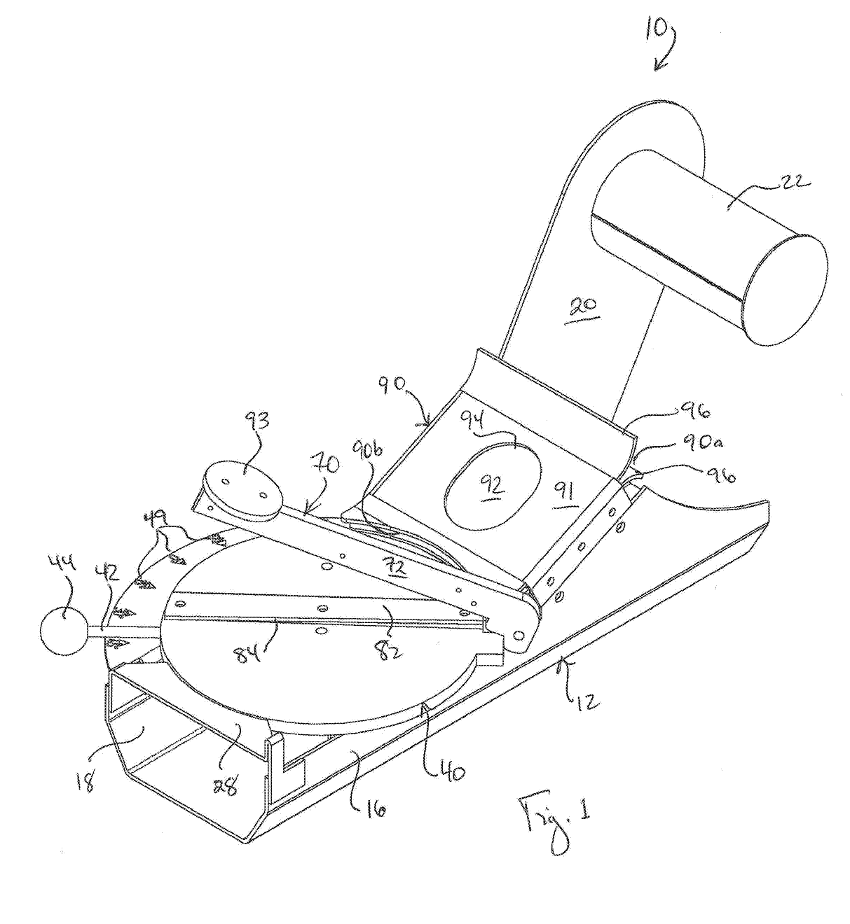

An embodiment of the ribbon cutter 10 of the invention is illustrated in FIG. 1. The ribbon cutter 10 is suitable for cutting flexible strips, whether made from fabric, paper, foil or any other material capable of retaining its integrity while being fed through the ribbon cutter 10, and is not limited to any particular type or composition of flexible strip or any particular use or application for a flexible strip. The ribbon cutter 10 of the invention may be used to cut any angle. In the embodiment shown markings are provided for cuts between 90 and 45 degrees in either direction.

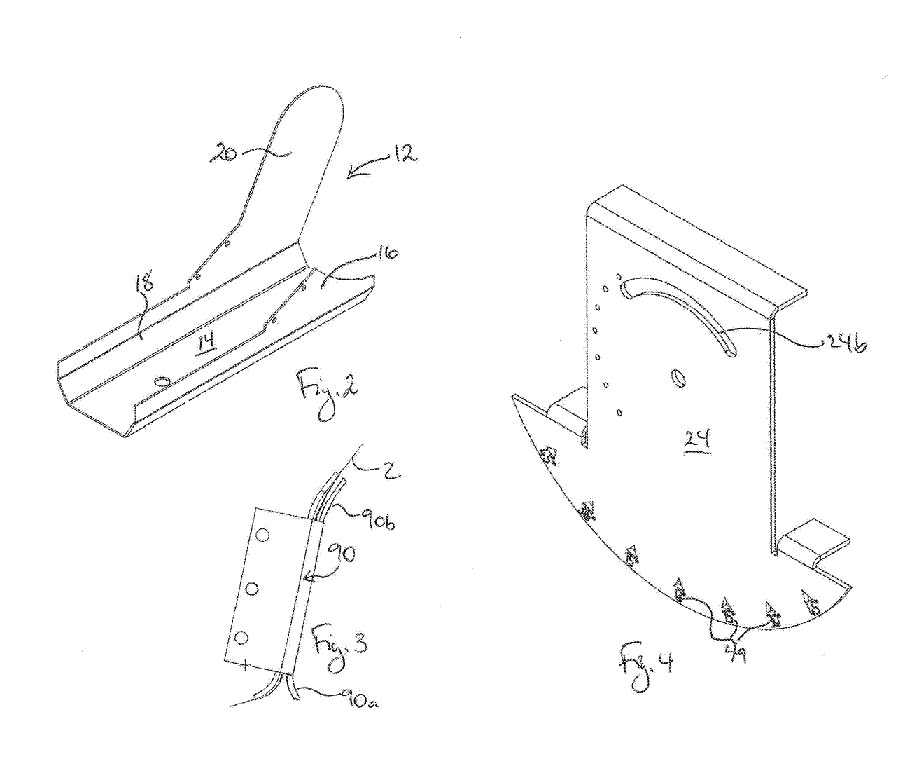

The ribbon cutter 10 comprises a base 12, illustrated in FIG. 2, in the preferred embodiment comprising a shoe having a bottom 14 and side walls 16, 18, and may for example be die stamped or otherwise formed from a suitable sheet metal such as galvanized steel. The base 12 may comprise an upstanding projection 20 supporting a roll holder 22 (seen in FIG. 1) on which a roll of ribbon 2 (shown in phantom in FIG. 5) may be mounted for convenience, which facilitates feeding the ribbon 2 in indeterminate lengths during use of the ribbon cutter 10. The ribbon 2 may alternatively be fed through the ribbon cutter 10 as pre-cut strips, in which case the upstanding projection 20 and roll holder 22 would be unnecessary.

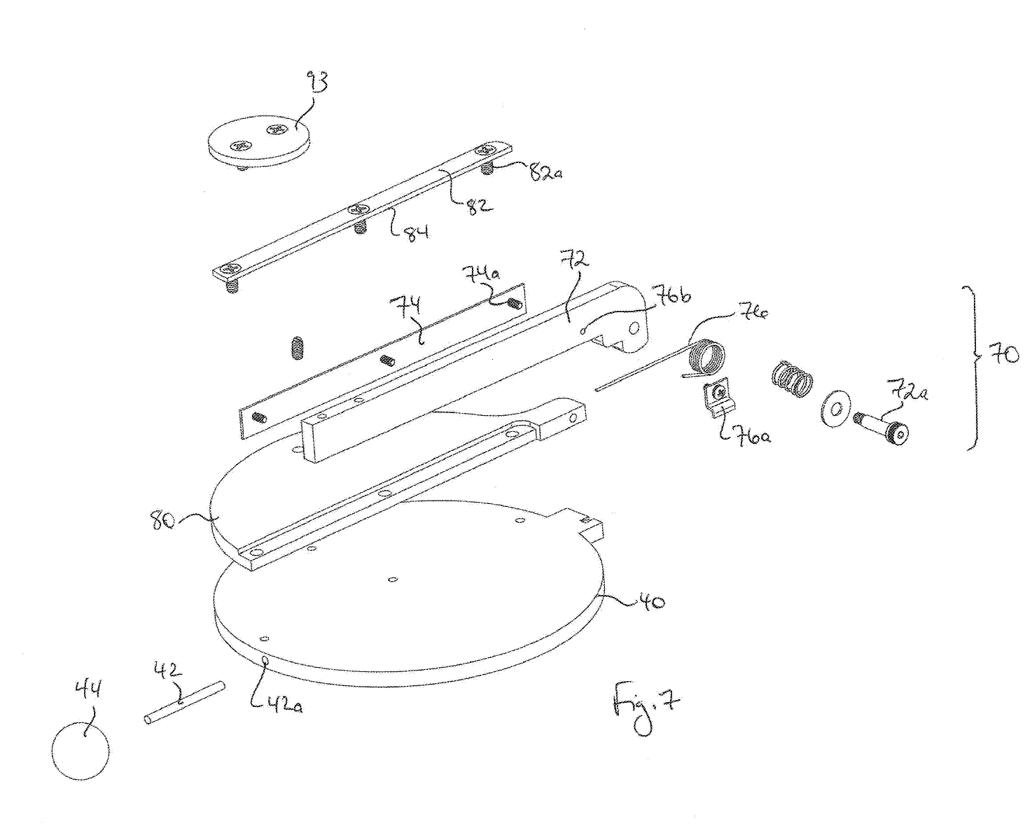

The base 12 supports a turntable 40, an embodiment of which is illustrated in detail in FIG. 7, which is mounted on the base 12 for movement between a plurality of rotational angles relative to the feed direction of the ribbon 2 (shown by the arrow in FIG. 5). In the embodiment illustrated a turntable support 24, best seen in FIGS. 5 and 6, is mounted across the base 12 and supported by (for example spot-welded to) the sides 16, 18.

A cutting arm 70 is pivotally connected to the turntable 40 for cutting the ribbon 2 at a selected angle determined by the rotational position of the turntable 40, as best seen in FIG. 1. The cutting arm 70, illustrated in detail in FIG. 7, may for example be affixed by a spring-loaded bolt 72a having an aluminium spacer and a threaded end projecting beyond the spacer for engagement to a cutting edge member 80 comprising a shearing edge 84. The shearing edge 84 may be formed on a shearing bar 82 as illustrated, which is affixed to the turntable 40 through the cutting edge member 80, as by screws 82a shown in FIG. 7, such that the shearing edge 84 is immediately adjacent to the contact position of the cutting arm 70 with the turntable 40. The cutting arm 70 comprises a cutting bar 72 supporting a blade 74, for example affixed to the cutting bar 72 by screws 74a.

In the preferred embodiment the cutting arm 70 is biased to the open position, for example by torsion spring 76 fixed by spring retainer 76a affixed to the cutting bar 72 as at 76b. The cutting arm 70 is thus movable between an open position for positioning the ribbon, shown in FIG. 1, and a cutting position abutting the shearing edge 84 of the cutting edge member 80 for cutting the ribbon 2. A hand rest 93 may be affixed to the cutting bar 72 to render depressing the cutting arm 70 more comfortable. In the embodiment illustrated the cutting edge 84 coacts with the blade 74 to facilitate the cutting of the ribbon 2, however in certain applications it may possible, depending upon the composition of the ribbon material, to cut solely by the action of the blade 74 against the turntable 40.

A ribbon guide 90 for feeding the ribbon 2 over the turntable 40 is mounted to the sides 16, 18 of the base 12, positioned with its input end 90a facing the roll of ribbon 2 and its payoff end adjacent to the turntable 40. The ribbon guide 90 comprises a trapping plate 91 fixed over a ribbon feeding surface 92 in spaced relation by sides 96 which are affixed to the base 12, allowing room for the ribbon 2 to slide through the ribbon guide 90 between the trapping plate 91 and the ribbon feeding surface 92. The trapping plate 91 comprises an opening 94 through which the user can insert a finger to manually draw the ribbon 2 through the ribbon guide 90 to the turntable 40, frictionally engaging the ribbon 2 by depressing the ribbon 2 against the ribbon feeding surface 92 so that the motion of the user's finger toward the turntable 40 draws the ribbon 2 through the ribbon guide 90. The input end 90a may be provided with fluted lips 96 to facilitate feeding the ribbon 2 into the ribbon guide 90.

The turntable 40 is rotationally mounted onto the turntable support 24, for example in the embodiment illustrated the turntable support 24 is positioned so that the turntable 40 nests between the payoff end 90b of the ribbon guide 90 and an end plate 28 mounted across the payoff end of the base 12 and supported by (for example spot-welded to) the sides 16, 18. The payoff end 90b of the ribbon guide 90 and the end plate 28 provide curved edges along the periphery of the turntable support 24 complementary to the curvature of the turntable 40, retaining the turntable 40 in position over the turntable support 24 while allowing the turntable 40 to rotate to the desired angle. A ball knob 44 may be affixed to the turntable 40, for example as by pin 42 extending into a peripheral bore 42a in the turntable 40, to facilitate rotating the turntable 40.

Optionally the turntable support 24 comprises a slot 24b into which a ball nose spring plunger (not shown) projecting from the bottom of the turntable 40 depends, which both facilitates placement of the turntable 40 onto the turntable support 24 in the correct position, and imposes a limit on the degree to which the turntable 40 may be rotated within the selected range.

In operation, a roll of ribbon 2 (not shown) is loaded onto the roll holder 22 and the free end of the ribbon 2 is inserted into the ribbon guide 90. The turntable 40 set to the desired rotational position corresponding to the selected mitre angle of the end to be cut, for example by grasping optional ball knob 48 and forcing the turntable to the desired position. The used manually draws the ribbon 2 through the ribbon guide 90 until the free end of the ribbon 2 projects out of the payoff end 90b of the ribbon guide 90. The user may cut the free end of the ribbon 2 to a desired angle, or if the free end of the ribbon already has the desired profile the user then draws the ribbon 2 across the turntable 40 to the desired length to be cut. Stabilizing the ribbon 2 with one hand, the user depresses the cutting arm 70 to cut the ribbon to the desired mitre, freeing the cut length of ribbon 2 from the roll.

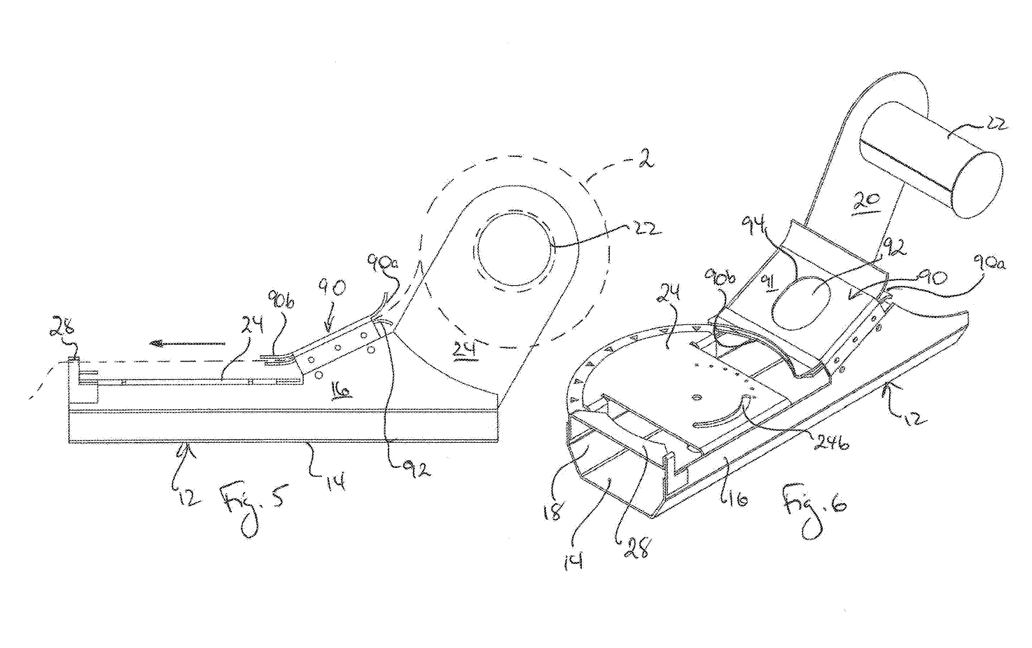

The turntable 40 may be free-rotating, or may be provided with clicks coacting with detents (not shown) to releasably hold the turntable 40 in specific popular rotational positions. In the preferred embodiment markings 49 may be provided along the edge of the turntable support 24, as shown in FIGS. 1 and 4, for ease of selecting the desired rotational angle for each particular cut.

Various embodiments of the present invention having been thus described in detail by way of example, it will be apparent to those skilled in the art that variations and modifications may be made without departing from the invention. The invention includes all such variations and modifications as fall within the scope of the appended claims.

1. A ribbon cutter, comprising
a base,
a turntable rotationally mounted on the base, for movement between a plurality of rotational angles relative to a feed direction of the ribbon,
a cutting arm pivotally connected to the turntable, movable between an open position for positioning the ribbon and a cutting position for cutting the ribbon at a selected angle determined by a rotational position of the turntable, and
a ribbon guide fixed over a ribbon feeding surface for feeding a ribbon over the turntable, the ribbon guide comprising an opening for manually drawing the ribbon through the ribbon guide to the turntable,
whereby the turntable can be set to a desired rotational position to cut the ribbon at a selected angle relative to a the feed direction of the ribbon.

2. The ribbon cutter of claim 1 wherein the cutting arm comprises a blade and the turntable comprises a shearing edge, whereby the blade of the cutting arm moves to the cutting position adjacent to the shearing edge.

3. The ribbon cutter of claim 1 comprising a ribbon roll holder affixed to the base.

4. The ribbon cutter of claim 1 wherein the turntable support extends beyond a periphery of the turntable and provides rotational angle markings at selected rotational positions of the cutting arm.

5. The ribbon cutter of claim 1 comprising a stop for limiting an angle of rotation of the turntable.

6. The ribbon cutter of claim 1 wherein the ribbon feeding surface is mounted at a downwardly extending angle relative to the turntable.
